(19) United States
(12) Patent Application Publication
(10) Pub. No.: US 2025/0192612 A1
(43) Pub. Date: Jun. 12, 2025

(54) WIRELESS CHARGING SYSTEM FOR APPLIANCES

(71) Applicant: Yank Technologies, Inc., Brooklyn, NY (US)

(72) Inventors: Joshua Aaron YANKOWITZ, Brooklyn, NY (US); Abdon Eduardo SAENZ DE VITERI, Brooklyn, NY (US)

(73) Assignee: Yank Technologies, Inc., Brooklyn, NY (US)

(21) Appl. No.: 18/847,172

(22) PCT Filed: Mar. 13, 2023
(86) PCT No.: PCT/US2023/064250

§ 371 Date: Sep. 13, 2024

Related U.S. Application Data
(60) Provisional application No. 63/269,453, filed on Mar. 16, 2022.

(51) Int. Cl. H02J 50/00; H02J 50/12

(52) U.S. Cl. CPC H02J 50/005; H02J 50/12; H02J 2310/40

(57) ABSTRACT

An apparatus includes sidewalls and a bottom portion defining an interior storage space with a wireless power transmitter comprising one or more transmitter antennas capacitively tuned to substantially resonate and driven by one or more amplifiers. The wireless power transmitter is embedded in at least one of the sidewalls or the bottom portion and is configured to wirelessly provide power to one or more wireless power receivers positioned within the interior storage space.

### CROSS-REFERENCE TO RELATED APPLICATIONS

This application claims priority to and benefit from U.S. Provisional Patent Application No. 63/269,453, entitled “WIRELESS CHARGING SYSTEM FOR APPLIANCES,” filed on Mar. 16, 2022, which is hereby incorporated by reference in its entirety.

### TECHNICAL FIELD

The present document relates to wireless power transmission technologies.

### BACKGROUND

Wireless technologies for powering and charging mobile and other electronic or electric devices and batteries have been developed. Such systems generally use a wireless power charger or transmitter, in combination with a wireless power receiver, to provide power to various devices.

### BRIEF SUMMARY

Techniques are disclosed to allow embodiments of storage containers to provide wireless power to wireless receivers placed inside the storage containers.

In one example aspect, an apparatus includes sidewalls and a bottom portion defining an interior storage space, a wireless power transmitter comprising one or more transmitter antennas capacitively tuned to substantially resonate and driven by one or more amplifiers; wherein the wireless power transmitter is embedded in at least one of the sidewalls or the bottom portion and is configured to wirelessly provide power to one or more wireless power receivers positioned within the interior storage space.

In another example aspect, an apparatus for wireless charging including an enclosure defined by sidewalls and a bottom portion; a lid defined by an interior surface facing the enclosure and an exterior surface opposite from the interior surface; a wireless power transmitter comprising one or more transmitter antennas capacitively tuned to substantially resonate and driven by one or more amplifiers; wherein the wireless power transmitter is embedded in at least one of the sidewalls or the bottom portion and is configured to wirelessly provide power to one or more wireless power receivers positioned within the enclosure or above the lid or the surface.

In another example aspect, an apparatus includes sidewalls and a bottom portion defining an interior storage space, wherein the sidewalls and/or the bottom portion comprise an electromagnetic conductive material; a wireless power transmitter comprising one or more transmit antennas capacitively tuned to substantially resonate and be driven by one or more amplifiers; wherein the wireless power transmitter is embedded in at least one of the sidewalls or the bottom portion and is configured to wirelessly provide power to one or more wireless power receivers positioned within the enclosure or above a lid of the apparatus; and a repeater antenna positioned between the one or more transmit antennas and a surface near which a wireless power receiver is placeable, wherein the repeater antenna is configured to suppress reflections from the wireless power receiver to the wireless power transmitter.

In another example aspect, an apparatus includes sidewalls and a bottom portion defining an interior storage space, a wireless power transmitter comprising one or more antennas capacitively tuned to substantially resonate and driven by one or more amplifiers, a wireless power transmitter comprising one or more transmit antennas disposed within the interior storage space, wherein the wireless power transmitter is configured to wirelessly provide power to one or more wireless power receivers positioned within the interior storage space.

In another example aspect, a method is disclosed for fabrication of a disclosed apparatus.

These, and other, aspects are disclosed throughout the document.

### BRIEF DESCRIPTION OF THE DRAWINGS

FIG. 1 depicts an example of a power tool wireless system.

FIG. 2 is an example embodiment showing power tool antenna positions.

FIG. 3 depicts an example of a power tool receiver.

FIG. 4 shows various geometries for transmitter antennas.

FIG. 5 shows an example of placement of an electronic housing.

FIG. 6 shows an example of a wireless charging system with various surface materials.

FIG. 7 shows an example of a wireless charging system with a cylindrical antenna.

FIG. 8 shows examples of wireless charging systems with a cylindrical antenna with separation materials.

FIG. 9 shows examples of wireless charging systems with drive and repeater antennas for the transmitter.

FIG. 10 shows an example of a drive and repeater antenna transmitter system.

FIG. 11 shows an example of driver and repeater antenna transmitter system with separation materials.

FIG. 12 shows an example of antenna mounted to top surface of a charge device on or near top of an enclosure.

FIG. 13 shows an example of an antenna embedded within enclosure lid.

FIG. 14 shows an example of a transmitted system embedded in a toolchest.

FIG. 15 depicts examples of enclosures in trunk and liftgate of a vehicle.

FIG. 16 shows an example of a surface charging system for a toolchest whereby the users can place tools on the surface similar to that of a toolbox.

FIG. 17 shows an example of a surface charging system for a portion of the toolchest.

FIGS. 18A-18D show examples of a volumetric charging system whereby tools can be placed in multiple positions in the drawer, such as holsters and the bottom-surface of the drawer.

### DETAILED DESCRIPTION

As appliances are used more frequently by workers and consumers, there is a greater need for powering these devices. Wireless power transfer can provide greater convenience and productivity to workers and consumers.

The techniques disclosed in the present document may be used to implement a wireless charging system whereby a transmitter embedded in a toolbox, toolchest, toolbin, packout, or any other similar storage unit wirelessly powers receiver(s) electrically connected to rechargeable batteries or tools and other appliances directly.

Throughout the day, workers often need to change tool batteries to keep conducting tasks. For workers like car mechanics, this can be multiple tools and potentially dozens of batteries packs changed on a daily basis. If the battery state is not well articulated to workers, this can be even more problematic because more time is spent not only physically swapping battery packs, but also looking for battery packs that are charged.

A wireless charging system can greatly improve the productivity of workers whereby a transmitter embedded in an enclosure wirelessly powers receiver(s) electrically connected to rechargeable batteries for the appliances or electrically connected to the appliances, such as tools, directly.

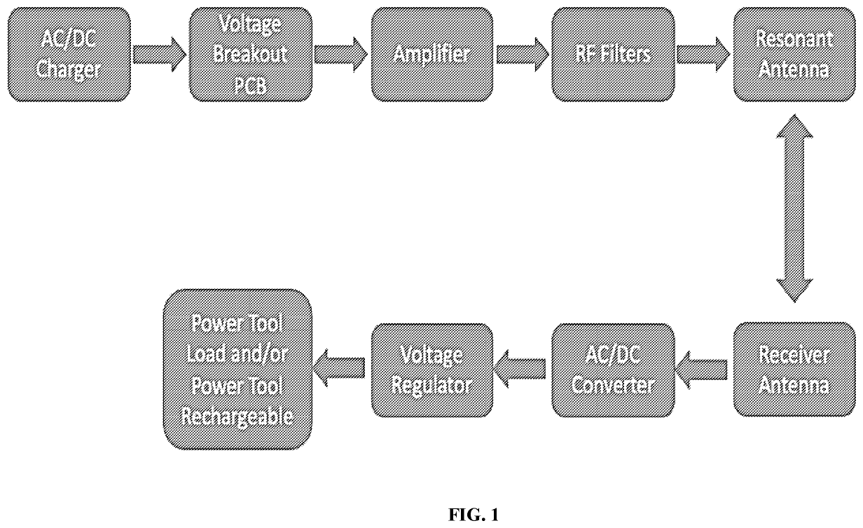

FIG. 1 illustrates an example system flow chart of an embodiment of the disclosed technology. An AC/DC charger is electrically coupled to a voltage breakout PCB, which includes a step-down converter for the amplifier digital logic and a boost converter for the amplifier input. The step-down converter for the amplifier digital logic can be buck converter or sepic (single ended primary inductor) converter. Furthermore, the voltage breakout board can have reverse-polarity protection, EMI filters, fuse protection, and other forms of EMI, short circuit, and reverse-polarity protection circuitry.

The power amplifier can be a switching amplifier, such as a series or parallel, resonant or off-resonant, Class D or Class E amplifier. Additionally, the power amplifier can be single-ended or differential, and can comprise an isolated switching amplifier topology. In a parallel-tuned power amplifier, the load network and matching network are tuned such that the transmitter antenna is in parallel rather than in series to the resonant capacitor with the load network of the amplifier also tuned at the same resonant frequency. That is, the entire power amplifier network operates completely in resonance rather than using an off-resonant load network. This way, the voltage across the transmitter is maximized and harmonics are reduced. By maximizing the voltage, there is higher oscillating current flowing through the transmitter antenna or a stronger magnetic field to be coupled with the receiver, especially in a loose coupling resonant inductive system, such as when the transmitter and receiver are physically far apart. In some embodiments, a transformer can also be included to further increase the oscillating voltage across the transmitter antenna and thereby further improve the flux linkage and power delivery between the transmitter and receiver. Additionally, the parallel resonant power amplifier is better protected from movements or changes in the position of the receiver or capacitive and inductive reflections from the surrounding environment that could cause a substantial change in the efficiency of the power amplifier. For further details, please see PCT Patent Application No. PCT/US2021/02112, entitled “Automotive Car Seat Wireless Charging System,” which is hereby incorporated by reference in its entirety.

The amplifier can then be electrically coupled to RF filters, such as bandpass filters, to attenuate undesirable harmonics and spurious signals. The signal then couples with antenna(s) tuned with resonant capacitors.

The receiver antenna(s) are excited with capacitors to substantially resonate and capture the flux from the transmitter antenna(s). This signal is then electrically connected to an AC/DC converter and regulator for various voltage levels depending on the appliance, but typically between 12V to 16V. Furthermore, the regulator can be used to ensure that the charge voltage or current stays within a range and/or does not shoot up beyond a safety limit. This can include a voltage regulator, current limiter, sepic converter, flyback converter, buck converter, boost converter, and other kinds of DC-DC converters.

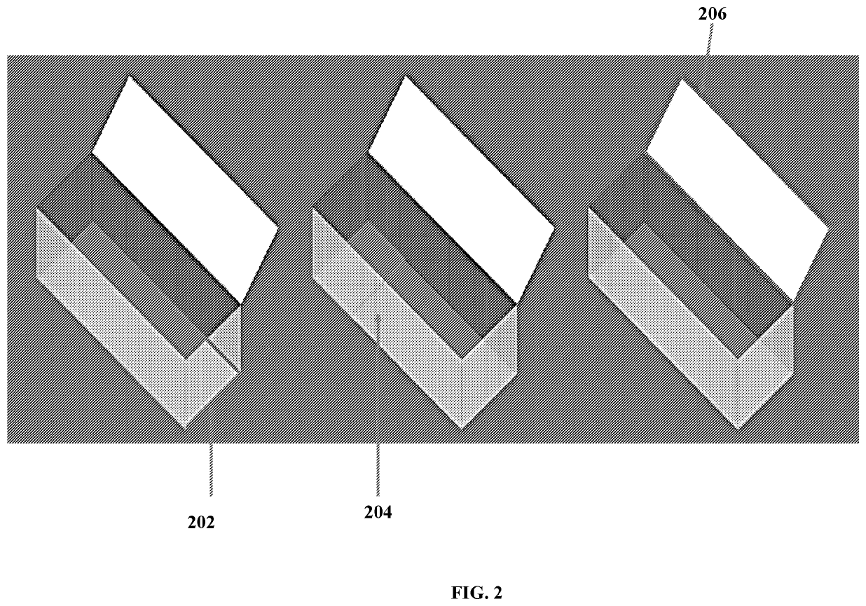

The transmitter antenna can be modified to meet charging area requirements for portions of the enclosure or the entirely of the surface area of a face of the enclosure. FIG. 2 illustrates the modified implementations depicting receiver coils 202, 204, 206 that can vary depending on the use case focus for the customers.

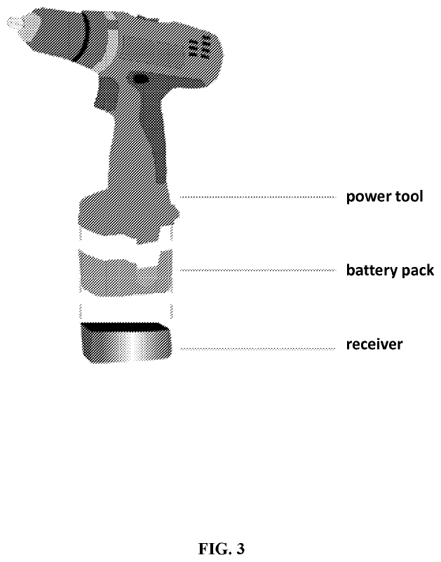

Furthermore, the receiver can be an exterior attachment to the battery pack of an appliance, such as a power tool, or directly embedded into the battery pack, tool, and similar other appliances as shown in FIG. 3. As an exterior attachment to the battery pack, the receiver can also be developed in a manner such that it is physically positioned between the appliance and the rechargeable battery. This may be helpful depending on where the power connections between the appliance and the rechargeable battery are located.

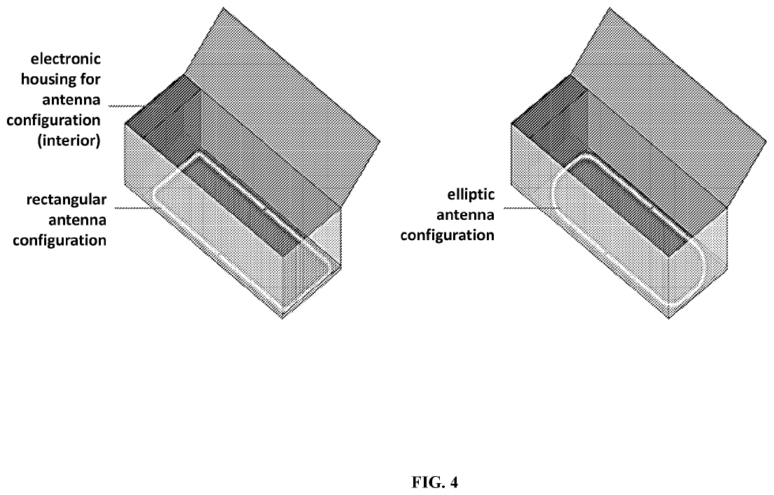

The antenna can be an electrodeposited antenna directly onto the toolbox lid, drawer, or another surface within the enclosure. Alternatively, the antenna can be a three-dimensional antenna or planar antenna mounted onto a surface within the enclosure. Furthermore, FIG. 4 illustrates that the antenna can also have varying geometries to improve performance, such as the intrinsic quality (“Q”) of the antenna.

In one embodiment, a three-dimensional antenna can be a surface spiral coil comprising a continuous conductor with no breaks or radio frequency discontinuities wound around a dielectric material at an angle to diminish the proximity effect at an operational frequency of the wireless charging transmitter device, and to maintain a high intrinsic quality factor (“Q”) of the surface spiral coil at the operating frequency (e.g., greater than 100, or up to 700 Q). The conductor can have a thickness of around 10 um to 40 um. A three-dimensional antenna can be utilized for the transmitter or the receiver to improve wireless power transfer efficiency. Additionally, the planar antenna and electrodeposited antennas also comprise continuous conductors with no break or radio frequency (RF) discontinuities. For further details, please see PCT Patent Application No. PCT/US2021/02112, entitled “Automotive Car Seat Wireless Charging System,” which is hereby incorporated by reference in its entirety.

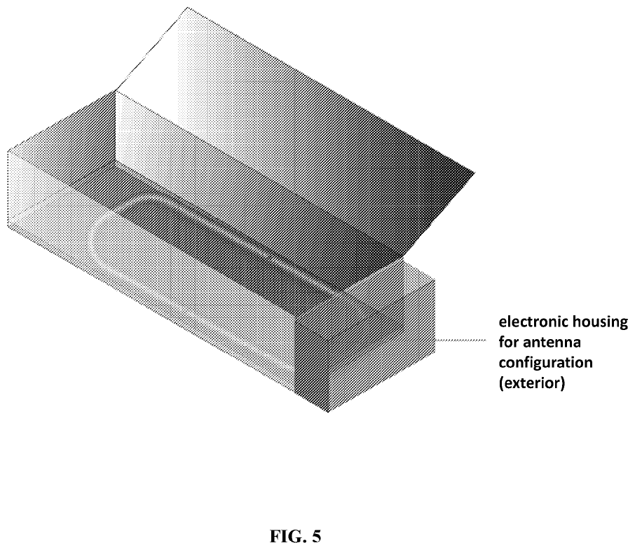

By comparing FIG. 4 to FIG. 5, there are different placements for the electronic housing to show that various placements of the electronic housing can be made in addition to the positions of the transmitter antenna. In this instance, the electronic housing can include part of if not all of the functions in the previously described voltage break-out PCB, amplifier(s), RF filters, and tuning components, such as those that substantially excite the transmitter antenna. There may be instances in which these functions would be more cost-effective to separately house depending on mechanical, electrical, and other design decisions.

Furthermore, for charging appliances within the interior of a toolbox drawer, pack-out, bin, toolchest, or other similar enclosures, the materials can be selected to optimize and confine the flux towards the placement of the receivers. For resonant inductive charging, developing high intrinsic quality (‘Q’) antennas is important design criteria to improve system efficiency, charging distance, and power delivered to the load. Intrinsic quality is the measure of inductive reactance over resistance. In other words, it is a measure of the energy stored over the energy dissipated for the antenna. It is a dimensionless parameter that is typically used as a barometer for antenna efficiency. The higher the ‘Q’ of the transmitter and receiver antennas, the better they will couple with one another. Nearby metal objects to the antennas can often ‘de-Q’ the antennas or reduce their intrinsic efficiency due to cross-coupling. However, an enclosure like a toolbox can be an important exception to this design rule.

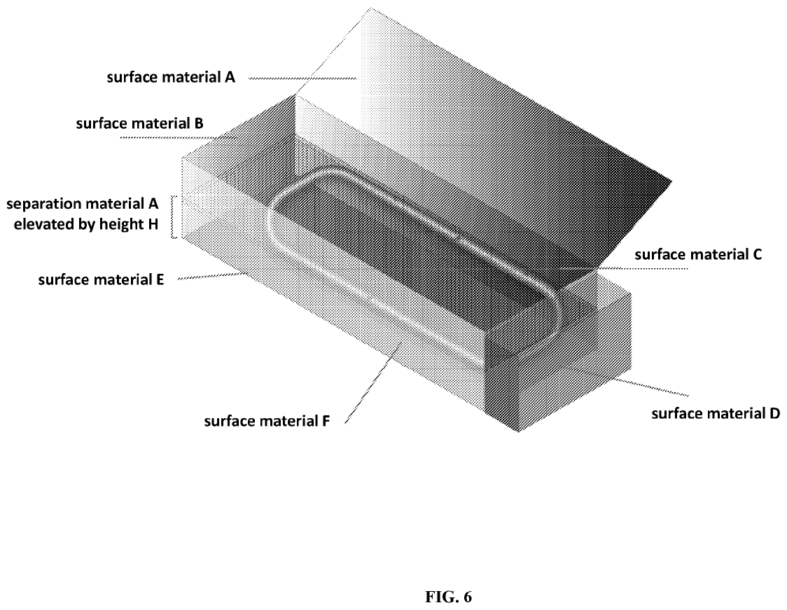

In FIG. 6, the toolbox consists of six surface materials that are conductive, such as aluminum or copper, to confine the magnetic flux within the toolbox structure. This is to essentially create a Faraday cage so that the magnetic fields are confined to the interior volume of the toolbox, toolbin, packout, or any other similar storage unit. Other conductive or ferromagnetic materials can be used such that the flux is mostly or entirely confined within the toolbox. A similar implementation can be made for a tool chest for a single drawer or multiple drawers within the tool chest to enable wireless charging.

In this example embodiment, a transmitter antenna is then embedded near the bottom surface of the toolbox to power tools and/or tool batteries within the entire volume of the toolbox, so the transmitter antenna is approximately the surface area of the bottom face of the toolbox with an electronic housing mounted on one end. However, because of the proximity to metal, a physical separation between the bottom metal face and the transmitter antenna may be desirable to improve the intrinsic ‘Q’ of the antenna but still confine the fields within the volume of the product. In this instance, the transmitter antenna may be mounted to a non-conductive separation material with a low dissipation factor, such as polypropylene plastic, that is in turn mounted to the bottom face of the antenna with a separation distance of “H.” The separation distance depends on the size of the antenna, product materials, targeted features, and intrinsic quality of the antenna desired for the application. It can range from typically several millimeters to several centimeters or more of spacing.

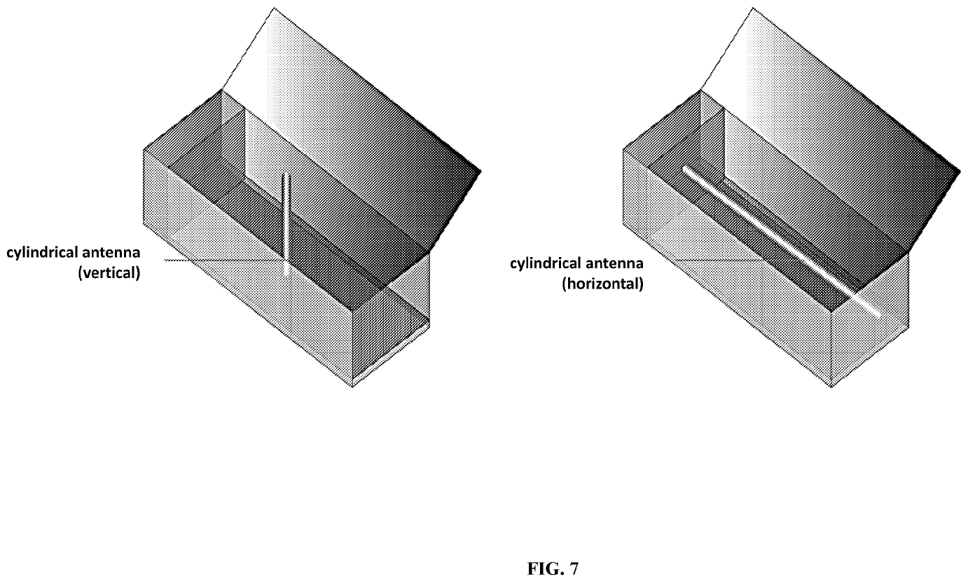

Referring to FIG. 7, alternatively, for a more uniform field distribution, an antenna can be implemented in the epicenter of the toolbox/toolchest/toolbin/pack-out/similar enclosure. The antenna in this case can be a planar, three-dimensional antenna, or a cylindrical antenna to distribute a more uniform field pattern. This can again be for a portion or the entirety of the toolbox volume and mounted on various faces of the toolbox as shown in the horizontal and vertical positions in FIG. 7.

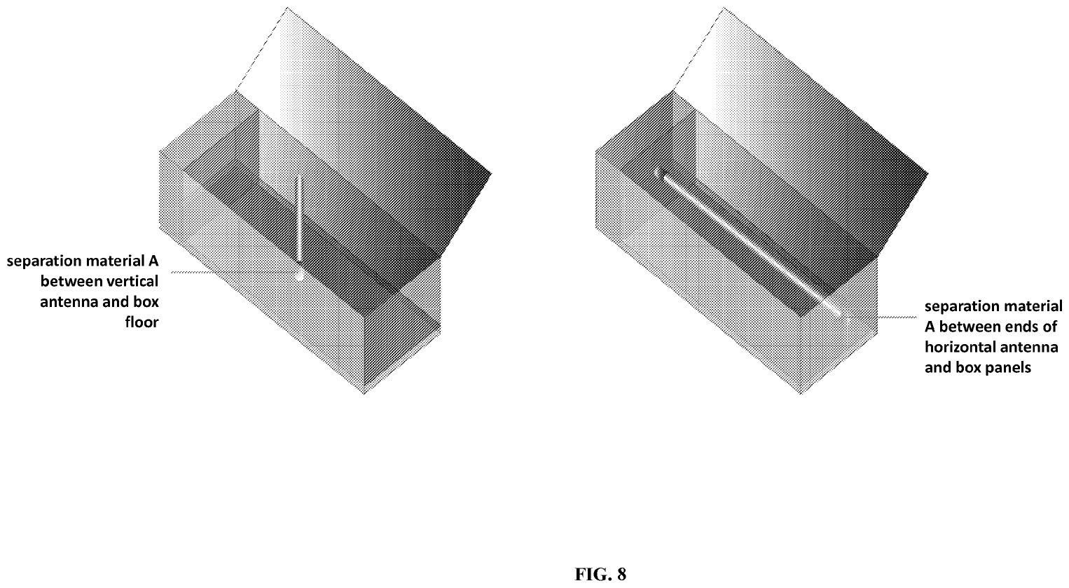

Referring to FIG. 8, furthermore, it may be desirable to have a separation material between the transmitter antenna the surfaces of the toolbox/toolchest/toolbin/packout/similar enclosure to improve the intrinsic quality of the antenna and/or better position the antenna toward the epicenter of the volume of the product or partitioned volume to power receiver(s).

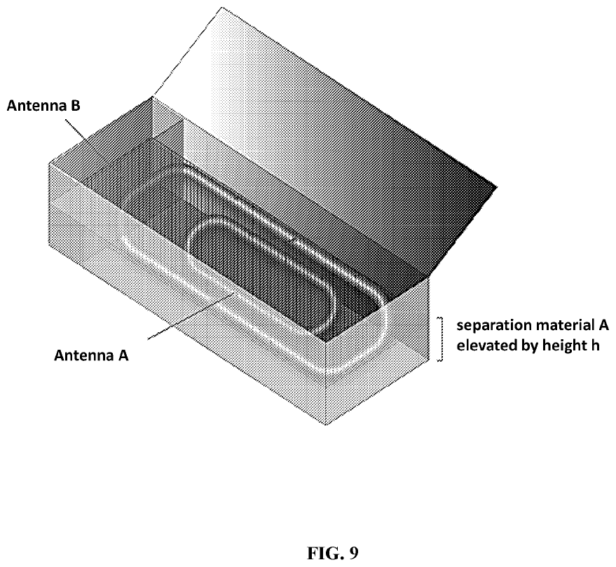

A potential challenge for a toolbox charging system is the reflections due to the movement of tools and introduction of new tools within the system. To further improve the robustness of the system to reflections, repeaters can be introduced to minimize the reflections back to the amplifier whereby the drive antenna for the amplifier is separated from the antenna that couples substantially with the receiver devices. In this instance, the repeater is capacitively tuned to substantially resonate with the amplifier drive antenna and placed at a distance relative to the drive antenna to couple substantially with it, such as within several centimeters. In this manner, when new receivers are introduced into the system, they will couple more with the repeater than with the drive antenna, reducing the reflections directly back to the amplifier, which can be especially important for a switching amplifier topology. FIG. 9 is an example embodiment of this drive and repeater antenna system.

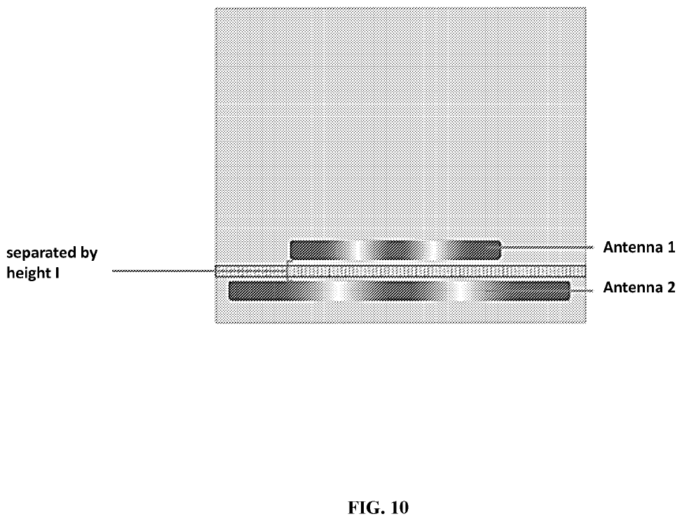

FIG. 10 illustrates an example stackup for a drive and repeater antenna transmitter system, such as that used in FIG. 9. The drive antenna is electrically connected to the amplifier system described in the flow chart of FIG. 1, while the repeater antenna is substantially resonating with tuning capacitors at nearly the same frequency of the drive coil. In this system, antenna 1 or antenna 2 can be designated as the drive or repeater antenna. Furthermore, the drive and repeater antenna are likely of different size. For example, the drive antenna may be designated to be smaller to reduce reflections from receiver devices, while the repeater antenna may be designated to be larger to increase the surface area coverage of a particular face of the toolbox, toolchest, toolbin, packout, or any other similar storage unit. In general, it may therefore be desirable to position the repeater antenna physically closer to where the receiver devices are positioned.

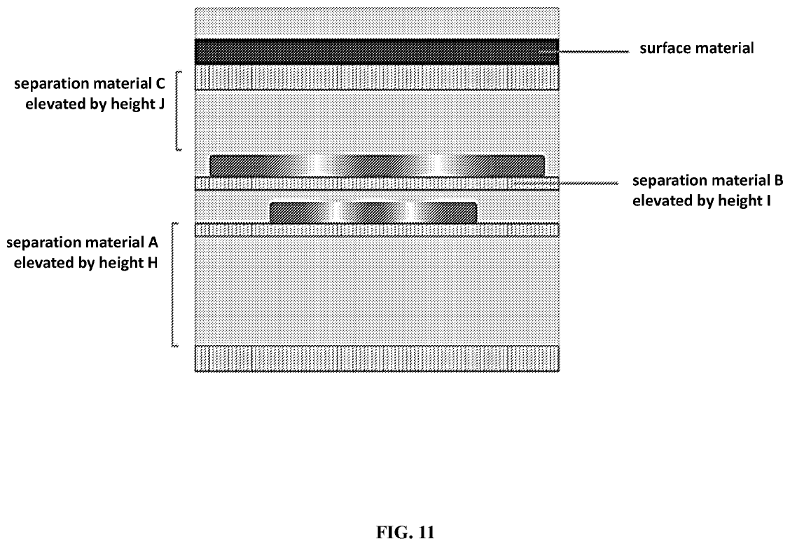

In order to optimize the system performance, it may be desirable to include separation materials between the drive and repeater antennas. Furthermore, it may also be desirable to include a separation material between the drive/repeater antenna and the surface. This is especially helpful for when the closest surface has conductive or a ferromagnetic material. In FIG. 11, there is a separation material A with height ‘H’ between the bottom-face surface of the toolbox and the drive antenna. Then, there is a separation material B with height “I” between the drive and repeater antennas. Lastly, a surface material can be on top of the repeater antenna whereby the receiver devices are placed.

The separation materials are again typically non-conductive with a low dissipation factor, such as polypropylene plastic, to improve system efficiency. The height of all separation materials can vary depending on the application. Furthermore, this same stackup can include an additional separation material C with height J between the surface closest to the receivers (“surface material” in FIG. 11) and the repeater/drive antenna. All of these embodiments are also applicable and possible for the enclosure illustrated in FIG. 9.

Furthermore, this configuration can be developed such that it is mounted within the product using the previously described embodiments with metal or ferromagnetic enclosure materials to increase the flux confinement within the product's volume. Alternatively, it can also be implemented to focus the flux for other regions of the enclosure, such as the top surface only.

Another embodiment of the system can be that the drive antenna and repeater transmitter system is mounted directly to a bottom surface of the toolbox, toolchest, toolbin, packout, or any other similar storage unit. However, referencing again FIG. 6, all the surface materials include conductive or ferromagnetic materials with the exception of the surface material A that is now non-conductive so that the flux is targeted to power receivers directly on top or nearby. Similar to previous embodiments, the transmitter antenna can be spaced at a distance from the bottom surface to minimize reflections and/or cross-coupling. Furthermore, the transmitter system can be a single antenna or a drive antenna and repeater system to further reduce the reflections from the receivers placed inside the enclosure.

The metallic or ferromagnetic sides of the product can concentrate the flux within the volume of the product as well as on top of the product. While the flux will be more concentrated within the product in comparison to on top of the product, this embodiment may offer more diverse features. For example, workers may want to charge tools and tools batteries throughout the day by placing them on top of the toolbox during active use and at night when the tools and tool batteries are placed within the toolbox and not used.

Throughout the day, workers may also dynamically use multiple appliances and place them on top of a toolbox, toolchest, toolbin, packout, or any other similar storage unit rather than inside the enclosure in order to charge and use appliances frequently. In this case, it would be advantageous to charge the tools on the top surface as well or as an alternative feature to charging within the volume of the product.

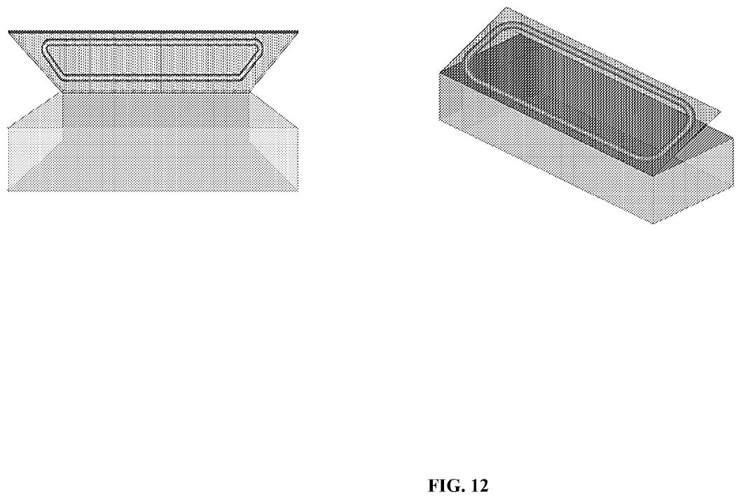

In this instance, the transmitter antenna may be mounted to the top surface of the enclosure to better focus the flux to the upper lid. FIG. 12 is an example visual representation of a transmitter antenna embedded into the top surface of a toolbox, toolchest, toolbin, packout, or any other similar storage unit.

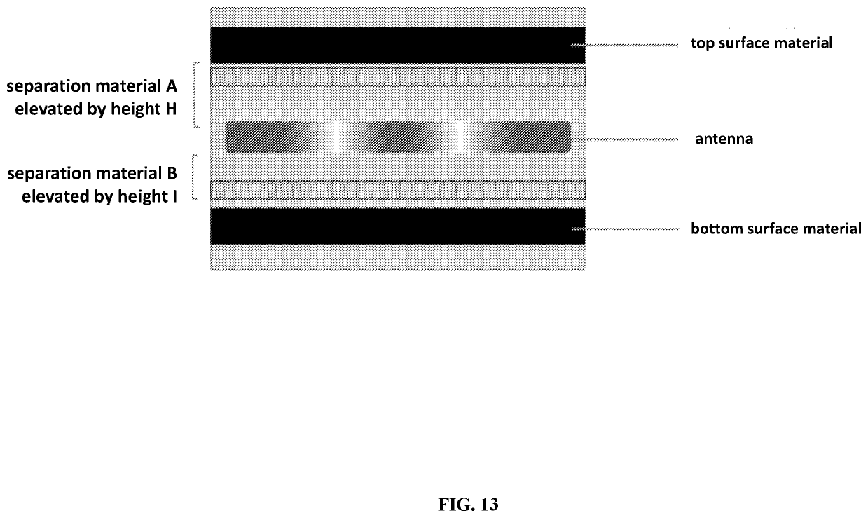

FIG. 13 illustrates an example stackup of this system. In this instance, there are two surface materials (top and bottom) with the materials directly contacting the antenna as separation materials A and B with separation distances of height H and I respectively. It is possible that the surface materials directly contact the antenna, but it may be preferable to have contact materials with lower dissipation factors if it is too expensive to procure for the surface materials, for example, to improve performance. Furthermore, similar to other implementation areas within the enclosure, the heights of the separation materials may change in order to optimize the system, such as reducing reflections to the amplifier or cross-coupling with nearby metal objects.

Like in previous example embodiments, a repeater system can be introduced to minimize reflections back to the amplifier. Furthermore, the transmitter antenna or the drive and repeater transmitter system can be spaced at a distance from the top lid. However, in this case, the goal may be to further reduce reflections back to the amplifier rather than reduce cross-coupling with the metal surfaces or objects within the enclosure. While it may be helpful to increase the spacing to nearby metal objects or surfaces within the enclosure, it will likely not be practical for the top lid material to be metallic because it will block the magnetic flux from coupling with the receivers placed near or on the top surface.

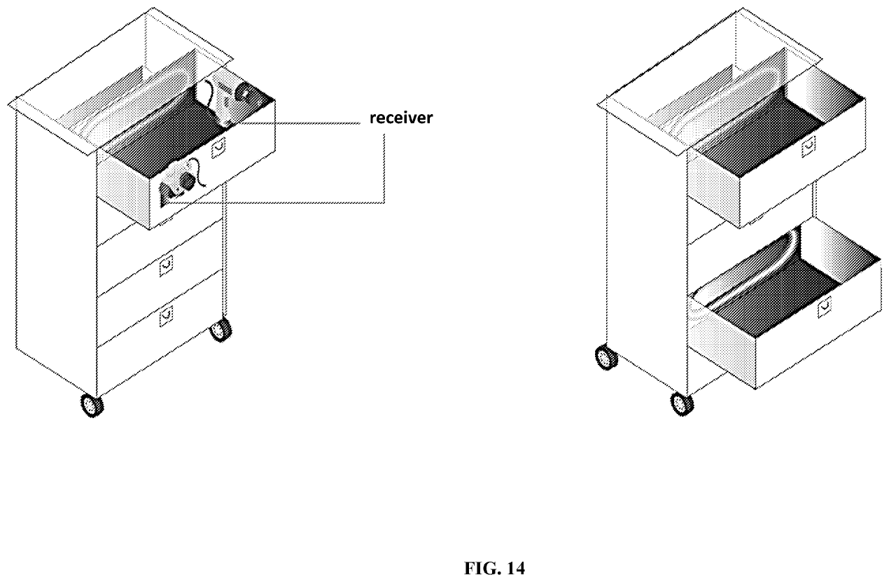

Furthermore, the “top” of the toolbox is relative to the target charging area for the receiver devices. In practice, the “top” in the stackup of FIG. 10 and FIG. 11 is relative to the placement of the receivers. For example, in the FIG. 12 embodiment, the user is interested in charging appliances directly on top of the enclosure. However, in FIG. 14, the appliances are actually placed inside and on the side of the toolchest drawer. Furthermore, there can be multiple transmitter systems, including drive and repeater antennas, within a single large enclosure, such as a toolchest, to increase the charging area coverage. It is also possible that they are driven by the same amplifier, such as with a parallel resonant amplifier topology, or by different amplifiers with varying output power requirements depending on the receivers expected to be placed within or near the respective transmitter systems. The system may also have a single consolidated electronic housing or multiple electronic housings in different areas in order to optimize cost and/or system efficiency. For example, an electronic housing for the amplifier electronics for each drawer in a toolchest.

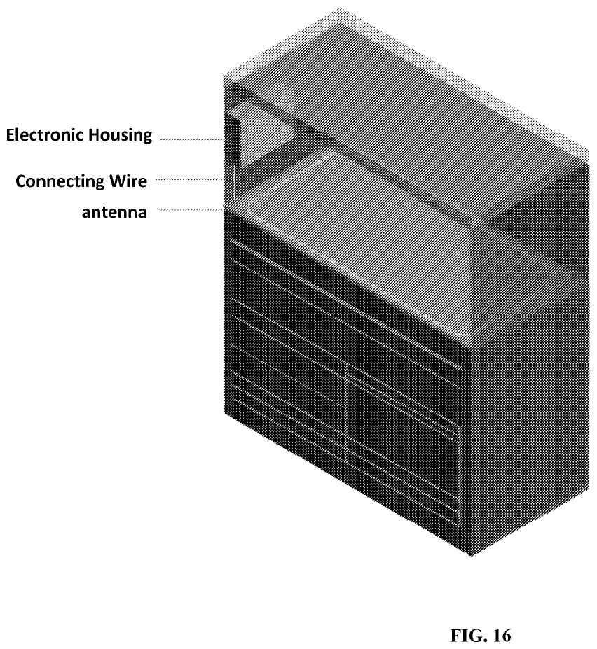

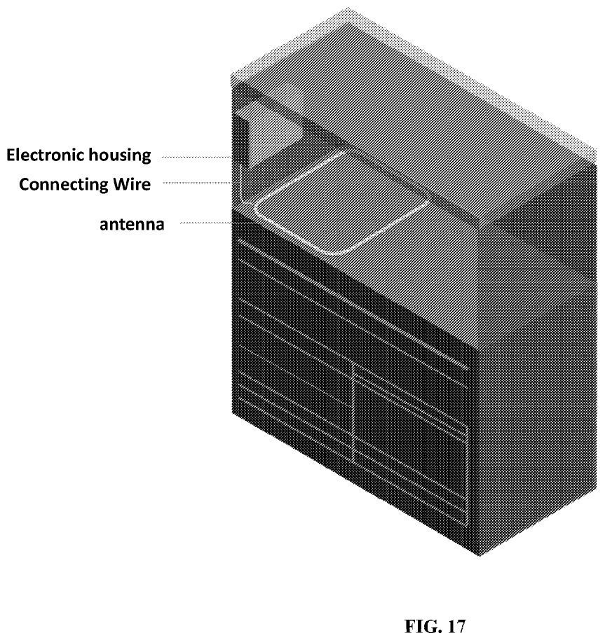

FIG. 16 illustrates an example embodiment of a surface charging system for a toolchest whereby the users can place tools on the surface similar to that of a toolbox. The transmitter antenna can be again embedded into the top surface with the previously described antenna topologies, such as those in FIGS. 10, 11, and/or 13. Furthermore, the electronic housing can be mounted in multiple locations in the toolchest such as interior panels and drawers. Meanwhile, FIG. 17 illustrates another example embodiment of a surface charging system for a portion of the toolchest. In some embodiments, it is possible that enabling wireless power for a portion of the surface is required in which case the size of the antenna would be approximately the surface area of the desired area to power appliances.

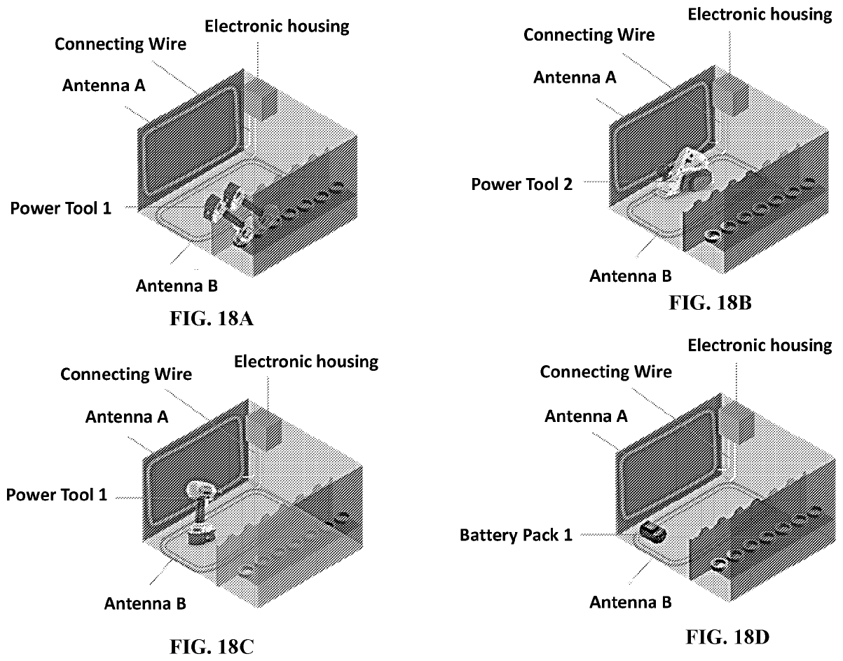

FIGS. 18A-18D illustrate example embodiments of a volumetric charging system whereby tools can be placed in multiple positions in the drawer, such as holsters and the bottom-surface of the drawer. In this instance, it may be optimal to have multiple transmitter antennas driven by a single transmitter electronics unit or multiple independent transmitter systems that can power tools in multiple positions within the volume (e.g., a toolchest drawer, packout, cooler, and other portable packing units). Each transmitter antenna can include all previously described embodiments, such as those described in FIGS. 4, 5, 6, 9, 10, and/or 11. In FIGS. 18A-18D, antenna A focuses the flux for appliances placed in the holster positions, while antenna B focuses the flux for appliances placed on the bottom-surface. For example, in FIG. 18A, the flux powering the tools in the holsters is primarily derived from antenna A. Meanwhile, in FIG. 18B the flux powering the appliance on the surface is primarily derived from antenna B. In FIG. 18C, another power tool appliance is shown, while in FIG. 18D, a rechargeable battery with the receiver device is shown. The receiver can either be integrated directly into the battery pack or placed as an accessory attachment and multiple appliances and batteries with receivers can be placed within the volume in holster and bottom-surface positions.

Furthermore, it may be desirable to wirelessly power a toolbox, packout, cooler, and other similar portable packing units in addition to the tools, rechargeable batteries, and other objects placed within them. For example, contractors often bring their own tools to a worksite where they travel via car or truck. In this case, the vehicle can be configured with a wireless transmitter system described in FIG. 1 with the voltage breakout PCB electrically connected to the vehicle power line rather than an AC/DC charger. This can be a trunk bed or fronk (front trunk) of new electric vehicles that don't house an internal combustion engine. This topology can again include all previously described embodiments of the system, such as a drive and repeater system, separation materials for various subsystems, and conductive or ferromagnetic enclosures to focus the flux in a particular region within the vehicle. In this case, the receiver is embedded into the toolbox, packout, cooler, and other similar portable packing units. This receiver captures the flux from the transmitter within the vehicle to provide wireless power to a rechargeable battery using the same topology described in FIG. 1. The receiver includes an AC/DC converter, a regulator, and potentially a battery protection circuit, if applicable and necessary, to provide the appropriate power for the rechargeable battery. In this instance, the power requirements are likely higher than that of receivers for appliances and appliance batteries, for example, placed within the enclosure.

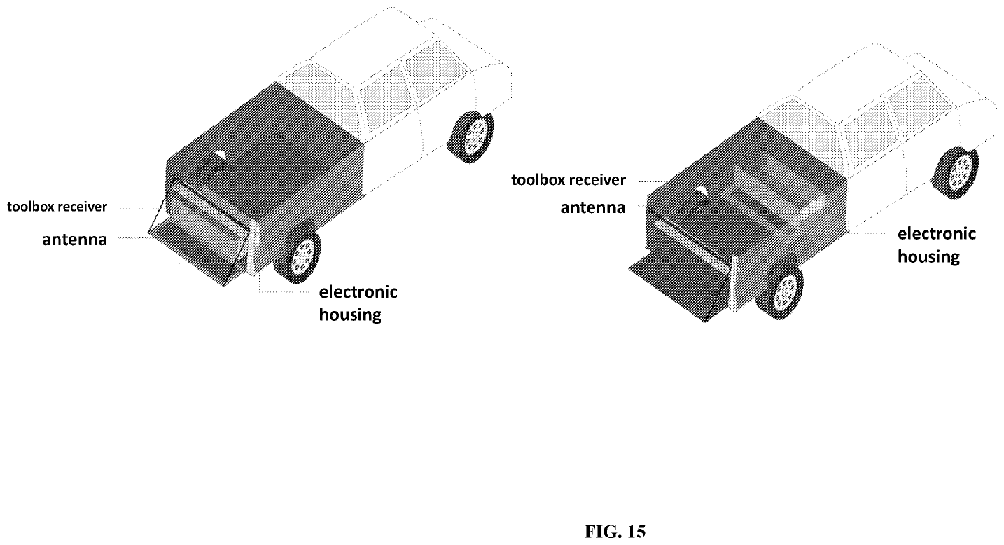

FIG. 15 illustrates two primary examples of the transmitter implementation for a liftgate (A) and trunk (B) embodiment whereby the transmitter resonant antenna is embedded within the vehicle that is electrically connected to an electronic housing, which in this case includes RF filters, an amplifier, and a voltage breakout PCB electrically connected to the wire harness of the vehicle. This can again include multiple physically separated electronic housings for each subsystem or partial subsystem to improve thermal operation characteristics via an isolated switching amplifier system, meet packaging requirements for the vehicle, and minimize cost.

Meanwhile, the receiver is embedded directly within the enclosure, such as a toolbox, to be wirelessly powered when placed in the trunk or on the liftgate. In this embodiment, it's possible that the enclosure does not include other receiver devices, such as tools or tool batteries, but rather receives power to recharge its own functions. For example, rather than a toolbox, the same system topology is applicable to a cooler. The cooler in this case does not charge other receiver devices.

Alternatively, a toolbox, toolchest, toolbin, packout, or any other similar storage unit can receive the power from the vehicle to provide that power to its rechargeable battery. Then, like similar embodiments, it can wirelessly power the receivers within that unit itself. In this case, the storage unit is functioning as a receiver relative to the vehicle and as a transmitter relative to the receiver devices placed inside it.

The following listing of solutions may be preferably implemented by some embodiments.
1. An apparatus, comprising: sidewalls and a bottom portion defining an interior storage space; and a wireless power transmitter comprising one or more transmitter antennas capacitively tuned to substantially resonate and driven by one or more amplifiers, wherein the wireless power transmitter is embedded in at least one of the sidewalls or the bottom portion and is configured to wirelessly provide power to one or more wireless power receivers positioned within the interior storage space. Some examples are depicted with reference to FIGS. 1 to 9,12, and 14.
2. The apparatus of solution 1, wherein a separation layer is placed between the one or more transmitter antennas and an exterior surface causing an increase in an intrinsic quality of at least one transmit antenna or reduce reflections back to the one or more amplifiers.
3. The apparatus of solutions 1-2, further including a lid that encloses the interior storage space.
4. The apparatus of solutions 1-3, wherein at least one of the sidewalls or the bottom portion comprises of a ferromagnetic or a conductive material.
5. The apparatus of solution 2, wherein the separation layer includes a repeater antenna, wherein the repeater antenna is separated from the one or more transmitter antennas by a first height and the repeater antenna is separated from the exterior surface by a second height.
6. The apparatus of any of solutions 2 and 5, wherein the one or more transmitter antennas are coplanar with the exterior surface of the bottom portion.
7. The apparatus of any of solutions 1-6, wherein the apparatus includes a power inlet configured to receive power from an external power supply.
8. The apparatus of solution 7, wherein the power inlet is configured to receive a vehicular power supply.
9. The apparatus of solution 3, wherein the apparatus includes a control mechanism that activates wireless power transmission selectively based on a closing position of the lid, a push-button, a touch sensor, or switch activation by a user.
10. The apparatus of any of solutions 1-9, the interior storage space is configured to place a wireless power receiver within the apparatus, wherein the wireless power receiver comprises a receiver antenna, a matching network, an AC/DC converter, and a regulator. For example, the matching network may be used to match the impedance of the receiving antenna with the subsequent circuit that drives power into a battery or the appliance directly. The AC/DC converter (alternating current/direct current) may be used to generate a DC voltage used for battery charging or powering the appliance directly. A regulator may be used to ensure that the charge voltage or current stays within a range and/or does not shoot up beyond a safety voltage.
11. An apparatus for wireless charging, comprising: an enclosure defined by sidewalls and a bottom portion; a lid defined by an interior surface facing the enclosure and an exterior surface opposite from the interior surface; and a wireless power transmitter comprising one or more transmitter antennas capacitively tuned to substantially resonate and driven by one or more amplifiers, wherein the wireless power transmitter is embedded in at least one of the sidewalls or the bottom portion and is configured to wirelessly provide power to one or more wireless power receivers positioned within the enclosure or above the lid. Some examples are depicted with reference to FIGS. 1 to 9 and 12.
12. The apparatus of solution 11, wherein at least one sidewalls or surfaces of the enclosure comprises of a ferromagnetic or a conductive material.
13. The apparatus of solution 12, wherein a separation layer is placed between the one or more transmitter antennas and an exterior surface, wherein the separation layer includes a repeater antenna, wherein the repeater antenna is separated from the one or more transmitter antennas by a first height and the repeater antenna is separated from the exterior surface by a second height.
14. The apparatus of any of solutions 11-13, wherein the one or more transmitter antennas are coplanar with the exterior surface of the bottom portion.
15. The apparatus of any of solutions 11-14, wherein the apparatus includes a power inlet configured to receive power from an external power supply.
16. The apparatus of solution 15, wherein the power inlet is configured to receive a vehicular power supply.
17. The apparatus of solution 11, wherein the apparatus includes a control mechanism that activates wireless power transmission selectively based on a closing position of the lid, a push-button, a touch sensor, or switch activation by a user.
18. The apparatus of any of solutions 11-17, the enclosure is configured to place a wireless power receiver within the apparatus, wherein the wireless power receiver comprises a receiver antenna, a matching network, an AC/DC converter, and a regulator.
19. An apparatus, comprising: sidewalls and a bottom portion defining an interior storage space, wherein the sidewalls and/or the bottom portion comprise an electromagnetic conductive material; a wireless power transmitter comprising one or more transmit antennas capacitively tuned to substantially resonate and be driven by one or more amplifiers; wherein the wireless power transmitter is embedded in at least one of the sidewalls or the bottom portion and is configured to wirelessly provide power to one or more wireless power receivers positioned within the interior storage space or above a lid of the apparatus; and a repeater antenna positioned between the one or more transmit antennas and a surface near which a wireless power receiver is placeable, wherein the repeater antenna is configured to suppress reflections from one or more wireless power receivers to the wireless power transmitter. Some examples are depicted with reference to FIGS. 1 to 9, 12, and 14.
20. The apparatus of solution 19, wherein the repeater antenna is capacitively tuned to resonate with the wireless power transmitter.
21. The apparatus of any of solutions 19-20, wherein a separation layer is placed between one or more transmitter antennas and an exterior surface to increase an intrinsic quality of the one or more transmit antennas or reduce reflections back to the one or more amplifiers.
22. The apparatus of solution 21, wherein the separation layer includes a repeater antenna, wherein the repeater antenna is separated from the one or more transmitter antennas by a first height and the repeater antenna is separated from the exterior surface by a second height.
23. The apparatus of any of solutions 19-22, wherein the one or more transmitter antennas are coplanar with an exterior surface of the bottom portion.
24. The apparatus of any of solutions 19-23, wherein the apparatus includes a power inlet configured to receive power from an external power supply.
25. The apparatus of solution 24, wherein the power inlet is configured to receive a vehicular power supply.
26. The apparatus of solution 19, wherein the apparatus includes a control mechanism that activates wireless power transmission selectively based on a closing position of the lid, a push-button, a touch sensor, or switch activation by a user.
27. The apparatus of any of solutions 19-26, the interior storage space is configured to place a wireless power receiver within the apparatus, wherein the wireless power receiver comprises a receiver antenna, a matching network, an AC/DC converter, and a regulator.
28. An apparatus, comprising: sidewalls and a bottom portion defining an interior storage space; a wireless power transmitter comprising one or more antennas capacitively tuned to substantially resonate and driven by one or more amplifiers; and a wireless power transmitter comprising one or more transmit antennas disposed within the interior storage space, wherein the wireless power transmitter is configured to wirelessly provide power to one or more wireless power receivers positioned within the interior storage space. Some examples are depicted with reference to FIGS. 1 to 9, 12, and 14.
29. The apparatus of solution 28, wherein the one or more transmit antennas comprise a cylindrical antenna placed vertically near the bottom portion.
30. The apparatus of any of solutions 28-29, wherein the one or more transmit antennas comprise a horizontal antenna placed horizontally across two opposing sidewalls.
31. The apparatus of any of solutions 28-30, wherein the one or more transmit antennas comprise a single antenna.
32. The apparatus of any of solutions 28-31, wherein the one or more transmit antennas comprise multiple non-overlapping antennas.
33. The apparatus of any of solutions 28-32, wherein the apparatus is a toolbox or a toolchest or a toolbin or a cooler.
34. The apparatus of any of solutions 28-33, wherein the one or more transmit antennas are rectangular shaped.
35. The apparatus of any of solutions 28-34, wherein the one or more transmit antennas are elliptical shaped.
36. The apparatus of any of solutions 28-35, further including an electronic housing, which includes the one or more amplifiers, placed on an exterior or interior surface of the apparatus.

The figures and above description provide a brief, general description of a suitable environment in which the invention can be implemented. The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations can perform routines having steps/blocks, or employ systems having blocks, in a different order, and some processes or blocks can be deleted, moved, added, subdivided, combined, or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further any specific numbers noted herein are only examples: alternative implementations can employ differing values or ranges.

These and other changes can be made to the invention in light of the above Detailed Description. While the above description describes certain examples of the invention, and describes the best mode contemplated, no matter how detailed the above appears in text, the invention can be practiced in many ways. Details of the system can vary considerably in its specific implementation, while still being encompassed by the invention disclosed herein. As noted above, terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. An apparatus, comprising:
sidewalls and a bottom portion defining an interior storage space; and
a wireless power transmitter comprising one or more transmitter antennas capacitively tuned to substantially resonate and driven by one or more amplifiers,
wherein the wireless power transmitter is embedded in at least one of the sidewalls or the bottom portion and is configured to wirelessly provide power to one or more wireless power receivers positioned within the interior storage space,
wherein the one or more wireless power receivers comprise at least one receiver antenna, a matching network, an AC-DC converter, and a DC-DC converter,
wherein the at least one receiver antenna substantially resonates at a comparable frequency to at least one of the one or more transmitter antennas.

2. The apparatus of claim 1, wherein a separation layer is placed between the one or more transmitter antennas and an exterior surface causing an increase in an intrinsic quality of at least one transmitter antenna or reduce reflections back to the one or more amplifiers.

3. The apparatus of claim 1, further including a lid that encloses the interior storage space, wherein at least one of the sidewalls or the bottom portion comprises of a ferromagnetic or a conductive material.

4.-6. (canceled)

7. The apparatus of claim 1, wherein the apparatus includes a power inlet configured to receive power from an external power supply, wherein the power inlet is configured to receive a vehicular power supply.

8. (canceled)

9. The apparatus of claim 3, wherein the apparatus includes a control mechanism that activates wireless power transmission selectively based on a closing position of the lid, a push-button, a touch sensor, or switch activation by a user.

10. (canceled)

11. An apparatus for wireless charging, comprising:
an enclosure defined by sidewalls and a bottom portion;
a lid defined by an interior surface facing the enclosure and an exterior surface opposite from the interior surface; and
a wireless power transmitter comprising one or more transmitter antennas capacitively tuned to substantially resonate and driven by one or more amplifiers,
wherein the wireless power transmitter is embedded in at least one of the sidewalls or the bottom portion and is configured to wirelessly provide power to one or more wireless power receivers positioned within the enclosure or above the lid,
wherein the enclosure is configured to place one or more wireless power receivers within the apparatus,
wherein the one or more wireless power receivers comprise at least one receiver antenna, a matching network, an AC-DC converter, and a DC-DC converter,
wherein the at least one receiver antenna substantially resonates at a comparable frequency to at least one of the one or more transmitter antennas.

12. The apparatus of claim 11, wherein at least one sidewalls or surfaces of the enclosure comprises of a ferromagnetic or a conductive material.

13.-14. (canceled)

15. The apparatus of claim 11, wherein the apparatus includes a power inlet configured to receive power from an external power supply, wherein the power inlet is configured to receive a vehicular power supply.

16. (canceled)

17. The apparatus of claim 11, wherein the apparatus includes a control mechanism that activates wireless power transmission selectively based on a closing position of the lid, a push-button, a touch sensor, or switch activation by a user.

18. (canceled)

19. An apparatus, comprising:
sidewalls and a bottom portion defining an interior storage space, wherein the sidewalls and/or the bottom portion comprise an electromagnetic conductive material;
a wireless power transmitter comprising one or more transmitter antennas capacitively tuned to substantially resonate and be driven by one or more amplifiers,
wherein the wireless power transmitter is embedded in at least one of the sidewalls or the bottom portion and is configured to wirelessly provide power to one or more wireless power receivers positioned within the interior storage space or above a lid of the apparatus; and
a repeater antenna positioned between the one or more transmitter antennas and a surface near which a wireless power receiver is placeable, wherein the repeater antenna is configured to suppress reflections from the wireless power receiver to the wireless power transmitter,
wherein the interior storage space is configured to place a wireless power receiver within the apparatus, wherein the wireless power receiver comprises one or more receiver antennas, one or more matching networks, one or more AC-DC converters, and/or one or more regulators.

20. The apparatus of claim 19, wherein the repeater antenna is capacitively tuned to resonate with the wireless power transmitter.

21. The apparatus of claim 19, including:
wherein a separation layer is placed between one or more transmitter antennas and an exterior surface to increase an intrinsic quality of the one or more transmitter antennas or reduce reflections back to the one or more amplifiers.

22.-23. (canceled)

24. The apparatus of claim 19, wherein the apparatus includes a power inlet configured to receive power from an external power supply, wherein the power inlet is configured to receive a vehicular power supply.

25. (canceled)

26. The apparatus of claim 19, wherein the apparatus includes a control mechanism that activates wireless power transmission selectively based on a closing position of the lid, a push-button, a touch sensor, or switch activation by a user.

27.-36. (canceled)

37. The apparatus of claim 1, wherein at least one of the one or more wireless power receivers is electrically connected to a power tool battery or embedded directly within a mechanical enclosure of the power tool battery.

38. The apparatus of claim 11, wherein at least one of the one or more wireless power receivers is electrically connected to a power tool battery or embedded directly within a mechanical enclosure of the power tool battery.
